(19) United States
(12) Patent Application Publication
(10) Pub. No.: US 2013/0319993 A1
(43) Pub. Date: Dec. 5, 2013

(54) SOLDERING IRON TIP

(71) Applicant: Ten-Chen Ho, Tu-Cheng (TW)

(72) Inventor: Ten-Chen Ho, Tu-Cheng (TW)

(73) Assignee: HON HAI PRECISION INDUSTRY CO., LTD., Tu-Cheng (TW)

(21) Appl. No.: 13/535,639

(22) Filed: Jun. 28, 2012

(30) Foreign Application Priority Data
Jun. 5, 2012 (CN) 201210182206.1

(51) Int. Cl. H05B 3/02

(52) U.S. Cl. 219/229

(57) ABSTRACT

A soldering iron tip includes a mounting portion to be connected to an soldering iron, and a U-shaped tip. The tip includes a connecting plate connected to the mounting portion and two tip portions extending from opposite ends of the connecting plate. The tip is made of material, which is resilient, heat conductive, and having a high temperature resistance.

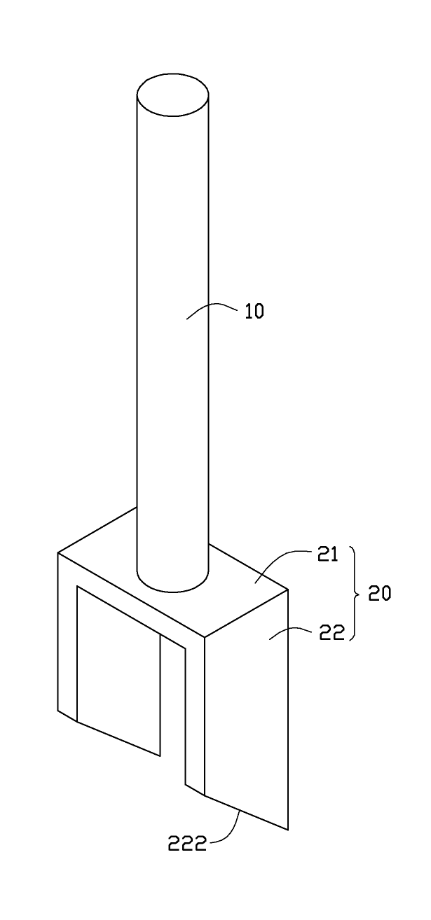

### BACKGROUND

1. Technical Field

The present disclosure relates to an iron tip, in particularly to a soldering iron tip.

2. Description of Related Art

Soldering irons are most often used for installation, repairs, and limited production work in electronics assembly. A common soldering iron includes a heated metal tip and an insulated handle. The heated metal tip includes only one tapered tip, which can process only one workpiece, such as a pin of a capacitor, at one time. So production efficiency is low.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the several views.

The FIGURE is an isometric view of a soldering iron tip, according to an exemplary embodiment.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

The FIGURE is an exemplary embodiment of a soldering iron tip. The soldering iron tip is used to be fixed to a main body of a soldering iron (not shown), to be heated by the soldering iron for soldering or heating a workpiece, such as a pin of an electrical capacitor or an electrical resistor. The soldering iron tip includes a cylindrical mounting portion 10 for connection to a soldering iron, and a substantially U-shaped tip 20. The soldering iron tip 20 includes a connecting plate 21 connected to a bottom end of the mounting portion 10 in a substantially perpendicular manner, and two tip portions 22 extending down from opposite ends of the connecting plate 21 in a substantially perpendicular manner A slope 222 is formed on a bottom end surface of each tip portion 22 opposite to the connecting plate 21, for adjusting the size of the touching area with the workpiece. In this exemplary embodiment, the soldering iron tip 20 is made of material, which is resilient, heat conductive, and having a high temperature resistance, such as beryllium-copper alloy.

In use, the tip portions 22 can process two workpieces or two opposite sides of one workpiece at the same time. When the distance between the tip portions 22 is different from a size of one workpiece, such as a pin of a capacitor, or a distance between two workpieces, the tip portions 22 can be elastically deformed, adjusting the distance between the tip portions 22, to match the size of one workpiece or the distance between two workpieces.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A soldering iron tip, comprising:
a mounting portion; and
a U-shaped tip comprising a connecting plate connected to the mounting portion and two tip portions extending from opposite ends of the connecting plate away from the mounting portion;
wherein the tip is made of material which is resilient, heat conductive, and having a high temperature resistance.

2. The soldering iron tip of claim 1, wherein a slope is formed on a distal end surface of each tip portion opposite to the connecting plate.

3. The soldering iron tip of claim 1, wherein the tip is made of beryllium copper alloy.

4. The soldering iron tip of claim 1, wherein the mounting portion is cylindrical.

5. The soldering iron tip of claim 1, wherein the mounting portion is perpendicular to the connecting plate.
